(19) United States
(12) Patent Application Publication
(10) Pub. No.: US 2011/0169228 A1
(43) Pub. Date: Jul. 14, 2011

(54) SEALING GASKET

(75) Inventors: Michael A. Karram, Flint, MI (US); Uk Jung Kim, Shelby Township, MI (US); Keith A. Stahl, Vassar, MI (US); Terry D. Arford, Auburn Hills, MI (US)

(73) Assignee: GM GLOBAL TECHNOLOGY OPERATIONS, INC., Detroit, MI (US)

(21) Appl. No.: 12/686,520

(22) Filed: Jan. 13, 2010

(51) Int. Cl. F16J 15/10

(52) U.S. Cl. 277/650

(57) ABSTRACT

A seal conforms to a surface geometry that enables the seal to meet performance objectives with a large number of material compositions. A corresponding seal system includes the seal having the surface geometry inside a groove defined by a member.

### TECHNICAL FIELD

This invention relates to gaskets and seals for providing sealed connections between components.

### BACKGROUND OF THE INVENTION

Seals and gaskets are employed in various components to prevent fluids from leaking outside of the component and to prevent contaminants from entering the component. The performance of a seal depends upon the geometry of the seal and the material comprising the seal. Accordingly, a seal geometry that meets performance objectives with one material may not meet performance objectives with another material. Exemplary performance objectives include contact pressure, contact width, and strain limits.

### SUMMARY OF THE INVENTION

A seal includes a seal body having an outer surface that conforms to a profile tolerance of 0.2 millimeters of an ideal surface geometry. The ideal surface geometry has first, second, third, fourth, fifth, and sixth points thereon. The ideal surface geometry also has first, second, third, fourth, and fifth segments, and is characterized by a first plane of symmetry and a second plane of symmetry. The first plane of symmetry intersects the ideal surface geometry at the first point, and the second plane of symmetry, which is substantially perpendicular to the first plane of symmetry, intersects the ideal surface geometry at the sixth point.

The first segment is an arc that has a radius of 17.50 millimeters and that connects the first point and the second point. The second segment is linear, has a length of 1.68 millimeters, and connects the second point to the third point. The third segment is an arc that has a radius of 2.40 millimeters, and that connects the third point to the fourth point. The fourth segment is an arc that has a radius of 0.66 millimeters, and that connects the fourth point to the fifth point. The fifth segment is an arc that has a radius of 2.20 millimeters, and that connects the fifth point to the sixth point.

The seal provided herein meets performance objectives for at least twenty-five different elastomer compositions and formulations. Accordingly, the seal provided herein provides a standardized design that may be used across a wide variety of applications and in a wide variety of operating environments, thereby eliminating the engineering and testing costs that may be associated with prior art seals.

According to another aspect of the disclosure, a seal body has an outer surface that conforms to a profile tolerance of 0.2 millimeters of an ideal surface geometry. The ideal surface geometry has first, second, third, fourth, fifth, sixth, and seventh points thereon, and has first, second, third, fourth, fifth, and sixth segments. A first plane of symmetry intersects the ideal surface geometry at the first point, and a second plane of symmetry, which is substantially perpendicular to the first plane of symmetry, intersects the ideal surface geometry at the seventh point.

The first segment is linear, has a length of 1.220 millimeters, and connects the first point and the second point. The second segment is an arc having a radius of 3.000 millimeters, and connects the second point to the third point. The third segment is linear, has a length of 1.450 millimeters, and connects the third point to the fourth point. The fourth segment is an arc having a radius of 1.430 millimeters, and connects the fourth point to the fifth point. The fifth segment is an arc having a radius of 0.645 millimeters, and connects the fifth point to the sixth point. The sixth segment is an arc having a radius of 1.890 millimeters, and connects the sixth point to the seventh point.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, cross-sectional view of a first member defining a groove, and a seal disposed within the groove;

FIG. 2 is a schematic depiction of the surface geometry of the seal of FIG. 1 at the cross-sectional plane of FIG. 1;

FIG. 3 is a schematic, cross-sectional view of the first member of FIG. 1;

FIG. 4 is a schematic, cross-sectional view of the first member and seal of FIG. 1 with a second member beginning to engage the seal;

FIG. 5 is a schematic, cross-sectional view of the first member, seal, and second member of FIG. 4, with the second member mounted to the first member and compressing the seal;

FIG. 6 is a schematic depiction of the surface geometry of an alternative seal configuration in accordance with the claimed invention;

FIG. 7 is a schematic, side view of the seal having the surface geometry of FIG. 6;

FIG. 8 is a schematic depiction of the surface geometry of a retention feature of the seal of FIG. 7; and

FIG. 9 is a schematic depiction of the surface geometry of a stabilization feature of the seal of FIG. 7.

### DESCRIPTION OF THE PREFERRED EMBODIMENTS

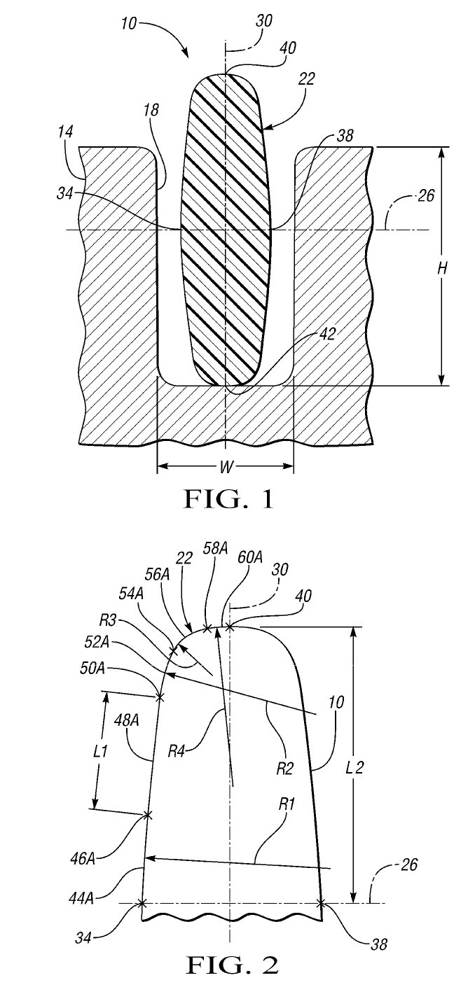

Referring to FIG. 1, a gasket or seal 10 for providing a sealing connection between a first member 14 and a second member (shown at 16 in FIGS. 4 and 5) is schematically depicted. The first member 14 defines a groove 18 in which the seal 10 is at least partially disposed. The outer surface 22 of the seal 10 is within 0.2 millimeters of an ideal surface geometry, and preferably conforms to within 0.15 millimeters of the ideal surface geometry. That is, the seal 10 conforms to a profile tolerance of 0.2 millimeters of the ideal surface geometry. Preferably, the seal 10 conforms to a profile tolerance of 0.15 millimeters of the ideal surface geometry. The ideal surface geometry of the outer surface 22 of seal 10 is symmetrical about a first plane of symmetry 26 and a second plane of symmetry 30.

The first and second planes 26, 30 of symmetry are perpendicular to one another. The two points 34, 38 of the ideal surface geometry that are in plane 26 are 2.52 millimeters apart, i.e., the width of the seal 10 having the ideal surface geometry is 2.52 millimeters. The two points 40, 42 of the ideal surface geometry that are in plane 30 are 7.82 millimeters apart, i.e., the height of the seal 10 having the ideal surface geometry is 7.82 millimeters.

Referring to FIG. 2, a segment 44A of the ideal surface geometry connects point 34 to point 46A, and is an arc characterized by a radius R1 of 17.50 millimeters. Linear segment 48A of the ideal surface geometry connects point 46A to point 50A and is characterized by a length L1 of 1.68 millimeters. Segment 52A of the ideal surface geometry connects point 50A to point 54A, and is an arc characterized by a radius R2 of 2.4 millimeters. Segment 56A of the ideal surface geometry connects point 54A to point 58A and is an arc characterized by a radius R3 of 0.66 millimeters. Segment 60A of the ideal surface geometry connects point 58A to point 40, and is an arc characterized by a radius R4 of 2.20 millimeters. The ideal surface geometry at point 40 is substantially parallel to plane of symmetry 26. The distance L2 from point 40 to plane 26 is 3.91 millimeters.

The remainder of the ideal surface geometry can be determined by the ideal surface geometry between points 34 and 40 because of the symmetry about planes 26 and 30. More specifically, and with reference to FIG. 4, a segment 44B of the ideal surface geometry connects point 38 to point 46B, and is an arc characterized by a radius of 17.50 millimeters. Linear segment 48B of the ideal surface geometry connects point 46B to point 50B and is characterized by a length of 1.68 millimeters. Segment 52B of the ideal surface geometry connects point 50B to point 54B, and is an arc characterized by a radius of 2.4 millimeters. Segment 56B of the ideal surface geometry connects point 54B to point 58B and is an arc characterized by a radius of 0.66 millimeters. Segment 60B of the ideal surface geometry connects point 58B to point 40, and is an arc characterized by a radius of 2.20 millimeters.

A segment 44C of the ideal surface geometry connects point 34 to point 46C, and is an arc characterized by a radius of 17.50 millimeters. Linear segment 48C of the ideal surface geometry connects point 46C to point 50C and is characterized by a length of 1.68 millimeters. Segment 52C of the ideal surface geometry connects point 50C to point 54C, and is an arc characterized by a radius of 2.4 millimeters. Segment 56C of the ideal surface geometry connects point 54C to point 58C and is an arc characterized by a radius of 0.66 millimeters. Segment 60C of the ideal surface geometry connects point 58C to point 42, and is an arc characterized by a radius of 2.20 millimeters.

Segment 44D of the ideal surface geometry connects point 38 to point 46D, and is an arc characterized by a radius of 17.50 millimeters. Linear segment 48D of the ideal surface geometry connects point 46D to point 50D and is characterized by a length of 1.68 millimeters. Segment 52D of the ideal surface geometry connects point 50D to point 54D, and is an arc characterized by a radius of 2.4 millimeters. Segment 56D of the ideal surface geometry connects point 54D to point 58D and is an arc characterized by a radius of 0.66 millimeters. Segment 60D of the ideal surface geometry connects point 58D to point 42, and is an arc characterized by a radius of 2.20 millimeters.

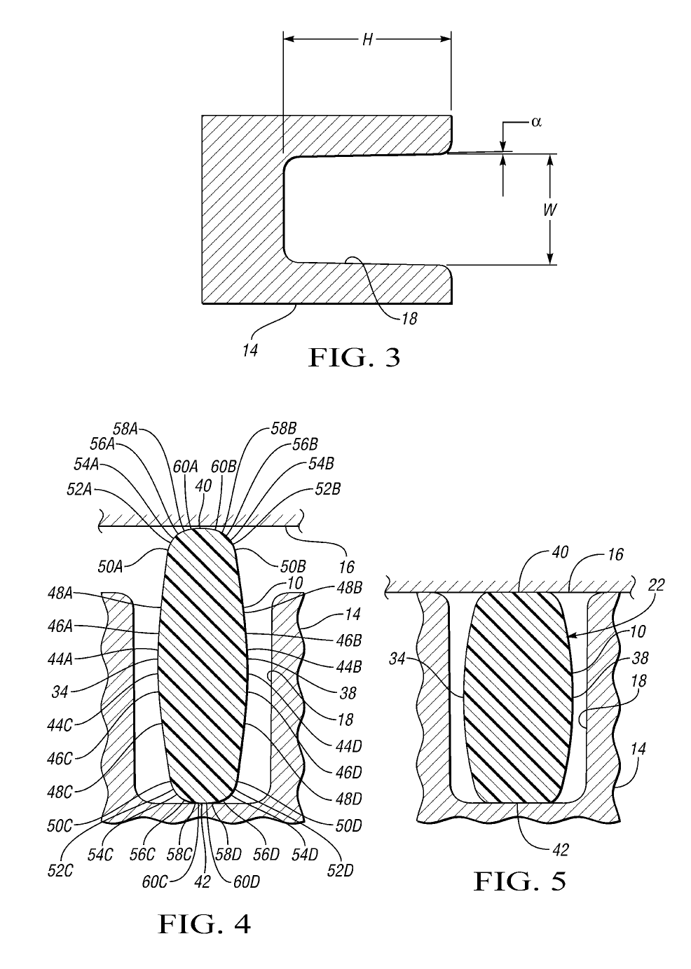

Referring to FIG. 3, the seal 10 is configured for use inside a standardized groove 18. Groove 18 is characterized by a width W of 3.9 millimeters and a height H of 6 millimeters. The lateral walls of the groove 18 are not parallel, but rather diverge at an angle α of 1°. The seal 10 may be used with other groove configurations within the scope of the claimed invention.

Referring to FIGS. 4 and 5, the second member 16 contacts the seal 10 at point 40 during attachment of the second member 16 to the first member 14. The seal 10 is not compressed in FIG. 4. As the second member 16 is pressed toward the first member, the second member 16 compresses the seal 10, as shown in FIG. 5. The contact area between member 16 and the seal 10 prevents the passage of fluids from one side of the seal 10 to the other. Those skilled in the art will recognize a variety of applications in which the seal 10 may be employed within the scope of the claimed invention. For example, member 14 may be part of a pump, an oil pan, a cam cover, etc.

As shown in FIG. 5, there are gaps between the compressed seal 10 and the lateral walls of the groove 18 at the section shown. Within the scope of the claimed invention, parts of the seal 10 (e.g., at various spaced intervals along the length of the seal) may deviate from the profile tolerance of 0.2 millimeters of the ideal surface geometry to provide more contact between the seal and the walls of the groove 18 in order to enhance retention of the seal 10 within the groove 18.

Referring to FIG. 6, wherein like reference numbers refer to like components from FIGS. 1-5, an alternative seal 10A is schematically depicted. The outer surface 22A of the seal 10A is within 0.2 millimeters of another ideal surface geometry, which is shown in FIG. 6, and preferably conforms to within 0.15 millimeters of the ideal surface geometry. That is, the seal 10A conforms to a profile tolerance of 0.2 millimeters of the ideal surface geometry. Preferably, the seal 10A conforms to a profile tolerance of 0.15 millimeters of the ideal surface geometry. The ideal surface geometry of the outer surface 22A of seal 10A is symmetrical about a first plane of symmetry 26 and a second plane of symmetry 30.

The first and second planes 26, 30 of symmetry are perpendicular to one another. Planes 26 and 30 bisect the seal 10A. Plane 26 intersects the surface 22A at two points 64, 68. Plane 30 intersects the surface 22A at two points, only one of which is shown at 72. The distance L3 from plane 26 to point 72 is 3.914 millimeters. Thus, seal 10A with the ideal surface geometry has a total height of 7.828 millimeters. The distance L4 from plane 30 to point 68 is 1.205 millimeters. Thus, the seal 10A with the ideal surface geometry has a total width of 2.410 millimeters.

A segment 76 of the ideal surface geometry connects point 68 to point 80. Segment 76 is linear and is characterized by a length L5 of 1.220 millimeters. Segment 84 of the ideal surface geometry connects point 88 to point 80, and is an arc characterized by a radius R5 of 3.000 millimeters. Linear segment 92 of the ideal surface geometry connects point 88 to point 96 and is characterized by a length L6 of 1.450 millimeters. Segment 100 of the ideal surface geometry connects point 96 to point 104, and is an arc characterized by a radius R6 of 1.430 millimeters. Segment 108 of the ideal surface geometry connects point 104 to point 112 and is an arc characterized by a radius R7 of 0.645 millimeters. Segment 116 of the ideal surface geometry connects point 112 to point 72, and is an arc characterized by a radius R8 of 1.890 millimeters. The ideal surface geometry at point 72 is substantially parallel to plane of symmetry 26. The remainder of the ideal surface geometry of seal 10A can be determined by the ideal surface geometry between points 68 and 72 because of the symmetry about planes 26 and 30.

The dimensions of the seals 10, 10A are such that the seals 10, 10A meet a wide variety of sealing performance objectives with a wide variety of elastomer material compositions. For example, seals 10, 10A may comprise ethylene propylene diene monomer (EPDM), fluoroelastomers, alkyl acrylate copolymer, nitrile butadiene rubber (NBR), ethylene acrylic elastomer, etc. Those skilled in the art will recognize other elastomers that may be employed within the scope of the claimed invention.

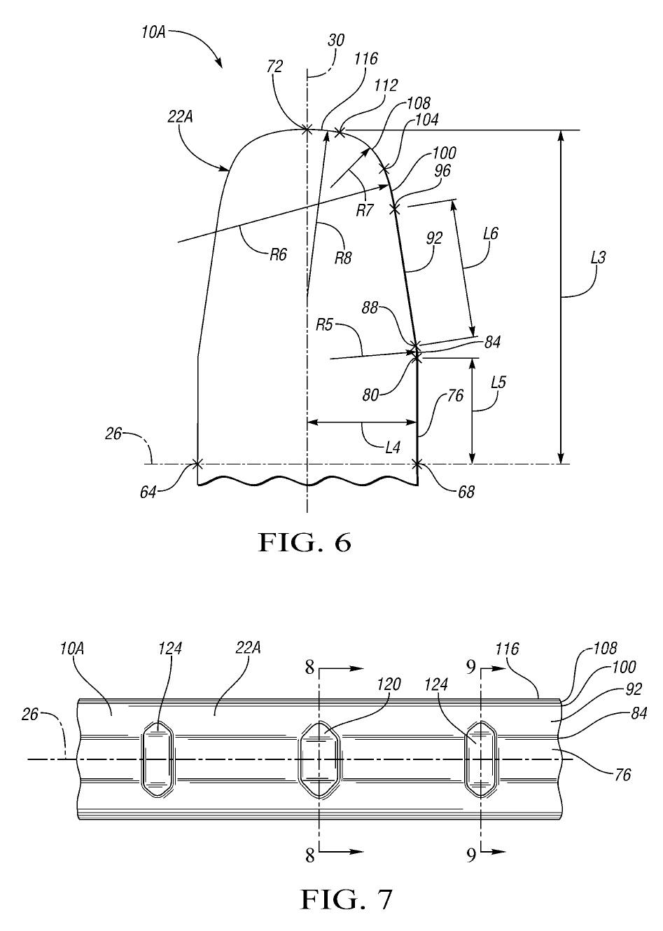

Referring to FIG. 7, wherein like reference numbers refer to like components from FIGS. 1-6, the surface 22A of seal 10A is characterized by retention features 120, which interact with the walls of the groove (shown at 18 in FIGS. 1 and 3-5) to retain the seal 10A within the groove, and stability features 124, which interact with the walls of the groove to maintain proper orientation of the seal 10A during assembly of member 16 to member 14. Retention features 120 and stabilization features 124 are locally widened portions of the seal 10A. The seal geometry shown in FIG. 6 is representative of the seal geometry at any vertical cross-section taken between the retention features 120 and stabilization features 124.

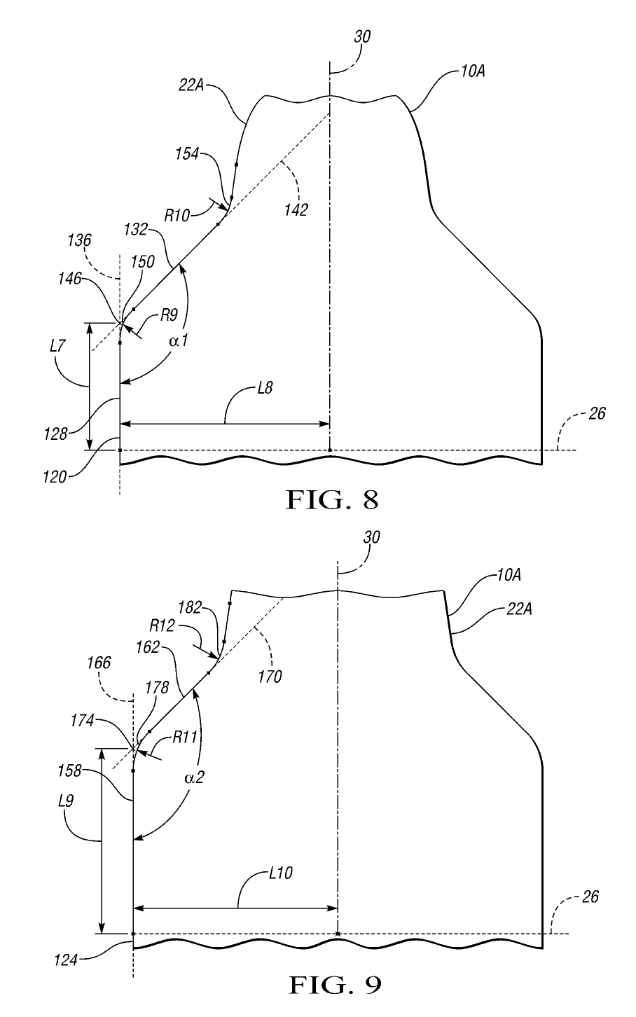

FIG. 8 schematically depicts the surface geometry of the seal 10A at the widest portion of the retention feature 120, i.e., at section 8-8. Referring to FIG. 8, wherein like reference numbers refer to like components from FIGS. 1-7, the outer surface 22A of the seal 10A at the retention feature 120 includes linear segments 128 and 132. Segment 128 is parallel with the plane of symmetry 30 and is partially coextensive with line 136. Segment 128 is displaced a distance L8 of 2.200 millimeters from plane 30, and thus, at the maximum width of retention feature 120, the width of the seal 10A is 4.400 millimeters.

Segment 132 is partially coextensive with line 142. Lines 136 and 142 intersect at point 146. Point 146 is a distance L7 of 1.330 millimeters from plane of symmetry 26. Segments 128 and 132 form an angle α1 of 135 degrees therebetween. A segment 150 of surface 22A is an arc that extends between segments 128 and 132. Segment 150 is characterized by a radius R9 of 0.500 millimeters. Segment 154 of surface 22A is an arc that extends on the opposite side of segment 132 from segment 150. Segment 154 is characterized by a radius R10 of 0.500 millimeters.

The retention feature 120 includes segments 128, 150, 132, and 154. The seal 10A is symmetrical about plane 26, and thus the geometry of the retention feature 120 on the opposite side of plane 26 can be determined by the geometry of segments 128, 150, 132, and 154. The seal 10A, being symmetrical about plane 30, includes two retention features, as shown in FIG. 8 on opposite sides of plane 30. The remainder of the outer surface 22A at section 8-8 conforms to the geometry shown in FIG. 6.

FIG. 9 schematically depicts the surface geometry of the seal 10A at the widest portion of one of the stabilization features 124, i.e., at section 9-9 (shown in FIG. 7). Referring to FIG. 9, wherein like reference numbers refer to like components from FIGS. 1-8, the outer surface 22A of the seal 10A at the stabilization feature 124 includes linear segments 158 and 162. Segment 158 is parallel with the plane of symmetry 30 and is partially coextensive with line 166. Segment 158 is displaced a distance L10 of 1.850 millimeters from plane 30, and thus, at the maximum width of stabilization feature 124, the width of the seal 10A is 3.700 millimeters.

Segment 162 is partially coextensive with line 170. Lines 166 and 170 intersect at point 174. Point 174 is a distance L9 of 1.680 millimeters from plane of symmetry 26. Segments 158 and 162 form an angle a2 of 135 degrees therebetween. A segment 178 of surface 22A is an arc that extends between segments 158 and 162. Segment 178 is characterized by a radius R11 of 0.500 millimeters. Segment 182 of surface 22A is an arc that extends on the opposite side of segment 162 from segment 178. Segment 182 is characterized by a radius R12 of 0.500 millimeters.

The stabilization feature 124 includes segments 158, 178, 162, and 182. The seal 10A is symmetrical about plane 26, and thus the geometry of the stabilization feature 124 on the opposite side of plane 26 can be determined by the geometry of segments 158, 178, 162, and 182. The seal 10A, being symmetrical about plane 30, includes two stabilization features on opposite sides of plane 30, as shown in FIG. 9. The remainder of the outer surface 22A at section 9-9 conforms to the geometry shown in FIG. 6.

While the best modes for carrying out the invention have been described in detail, those familiar with the art to which this invention relates will recognize various alternative designs and embodiments for practicing the invention within the scope of the appended claims.

1. A seal comprising:
a seal body having an outer surface that conforms to a profile tolerance of 0.2 millimeters of an ideal surface geometry;
the ideal surface geometry having first, second, third, fourth, fifth, and sixth points thereon, having first, second, third, fourth, and fifth segments, and being characterized by a first plane of symmetry that intersects the ideal surface geometry at the first point, and a second plane of symmetry that is substantially perpendicular to the first plane of symmetry and that intersects the ideal surface geometry at the sixth point;
the first segment being an arc having a radius of 17.50 millimeters and connecting the first point and the second point;
the second segment being linear, having a length of 1.68 millimeters, and connecting the second point to the third point;
the third segment being an arc having a radius of 2.40 millimeters, and connecting the third point to the fourth point;
the fourth segment being an arc having a radius of 0.66 millimeters, and connecting the fourth point to the fifth point; and
the fifth segment being an arc having a radius of 2.20 millimeters, and connecting the fifth point to the sixth point.

2. The seal of claim 1, wherein the seal comprises an elastomer.

3. The seal of claim 2, wherein the elastomer is selected from the group consisting of ethylene propylene diene monomer, fluoroelastomer, alkyl acrylate copolymer, nitrile butadiene rubber, and ethylene acrylic elastomer.

4. The seal of claim 1, wherein the seal body conforms to within 0.15 millimeters of the ideal surface geometry.

5. A seal assembly comprising:
a first member defining a groove;
a seal being at least partially disposed within the groove, the seal having an outer surface that conforms to a profile tolerance of 0.2 millimeters of an ideal surface geometry when the seal is in an uncompressed state;
the ideal surface geometry having first, second, third, fourth, fifth, and sixth points thereon, having first, second, third, fourth, and fifth segments, and being characterized by a first plane of symmetry that intersects the ideal surface geometry at the first point, and a second plane of symmetry that is substantially perpendicular to the first plane of symmetry and that intersects the ideal surface geometry at the sixth point;
the first segment being an arc having a radius of 17.50 millimeters and connecting the first point and the second point;
the second segment being linear, having a length of 1.68 millimeters, and connecting the second point to the third point;
the third segment being an arc having a radius of 2.40 millimeters, and connecting the third point to the fourth point;
the fourth segment being an arc having a radius of 0.66 millimeters, and connecting the fourth point to the fifth point; and
the fifth segment being an arc having a radius of 2.20 millimeters, and connecting the fifth point to the sixth point.

6. The seal assembly of claim 5, further comprising a second member compressing the seal.

7. The seal assembly of claim 5, wherein the seal comprises an elastomer.

8. The seal assembly of claim 7, wherein the elastomer is selected from the group consisting of ethylene propylene diene monomer, fluoroelastomer, alkyl acrylate copolymer, nitrile butadiene rubber, and ethylene acrylic elastomer.

9. The seal assembly of claim 5, wherein the first member is one of a pump, an oil pan, and a cam cover.

10. The seal assembly of claim 5, wherein the outer surface conforms to a profile tolerance of 0.15 millimeters of the ideal surface geometry when the seal is in an uncompressed state

11. A seal comprising:
a seal body having an outer surface that conforms to a profile tolerance of 0.2 millimeters of an ideal surface geometry;
the ideal surface geometry having first, second, third, fourth, fifth, sixth, and seventh points thereon, having first, second, third, fourth, fifth, and sixth segments, and being characterized by a first plane of symmetry that intersects the ideal surface geometry at the first point, and a second plane of symmetry that is substantially perpendicular to the first plane of symmetry and that intersects the ideal surface geometry at the seventh point;
the first segment being linear, having a length of 1.220 millimeters, and connecting the first point and the second point;
the second segment being an arc having a radius of 3.000 millimeters, and connecting the second point to the third point;
the third segment being linear, having a length of 1.450 millimeters, and connecting the third point to the fourth point;
the fourth segment being an arc having a radius of 1.430 millimeters, and connecting the fourth point to the fifth point;
the fifth segment being an arc having a radius of 0.645 millimeters, and connecting the fifth point to the sixth point; and
the sixth segment being an arc having a radius of 1.890 millimeters, and connecting the sixth point to the seventh point.

12. The seal of claim 11, wherein the seal comprises an elastomer.

13. The seal of claim 12, wherein the elastomer is selected from the group consisting of ethylene propylene diene monomer, fluoroelastomer, alkyl acrylate copolymer, nitrile butadiene rubber, and ethylene acrylic elastomer.

14. The seal of claim 11, wherein the outer surface conforms to a profile tolerance of 0.15 millimeters of the ideal surface geometry.

15. The seal of claim 11, wherein the ideal surface geometry includes a feature having a seventh segment being parallel to the second plane of symmetry, and an eighth segment that is linear and forms an angle of 135 degrees with the seventh segment.

16. The seal of claim 15, wherein the seventh segment is 2.200 millimeters from the second plane.

17. The seal of claim 15, wherein the seventh segment is 1.850 millimeters from the second plane.
